(19) United States
(12) Patent Application Publication
(10) Pub. No.: US 2019/0030942 A1
(43) Pub. Date: Jan. 31, 2019

(54) Greeting Card Assembly

(71) Applicant: Alberta Haislah, Cleveland, OH (US)

(72) Inventor: Alberta Haislah, Cleveland, OH (US)

(21) Appl. No.: 15/660,664

(22) Filed: Jul. 26, 2017

(51) Int. Cl. B42D 15/04; G09F 1/04

(52) U.S. Cl. CPC B42D 15/045; G09F 1/04

(57) ABSTRACT

A greeting card assembly for celebrating holidays includes a card. The card has a fold therein to define a first half that is hingedly coupled to a second half. A container is removably coupled to the card and the container is comprised of a translucent material. A plurality of objects is positioned in the container. The plurality of objects is selectively removable from the container when the container is removed from the card.

### (b) CROSS-REFERENCE TO RELATED APPLICATIONS

### Not Applicable

### (c) STATEMENT REGARDING FEDERALLY SPONSORED RESEARCH OR DEVELOPMENT

### Not Applicable

### (d) THE NAMES OF THE PARTIES TO A JOINT RESEARCH AGREEMENT

### Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### (f) STATEMENT REGARDING PRIOR DISCLOSURES BY THE INVENTOR OR JOINT INVENTOR

### Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to card devices and more particularly pertains to a new card device for celebrating holidays.

### (h) BRIEF SUMMARY OF THE INVENTION

An embodiment of the disclosure meets the needs presented above by generally comprising a card. The card has a fold therein to define a first half that is hingedly coupled to a second half. A container is removably coupled to the card and the container is comprised of a translucent material. A plurality of objects is positioned in the container. The plurality of objects is selectively removable from the container when the container is removed from the card.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a greeting card assembly according to an embodiment of the disclosure.

FIG. 2 is a bottom view of an embodiment of the disclosure.

FIG. 3 is a front view of an embodiment of the disclosure.

FIG. 4 is a cross sectional view taken along line 4-4 of FIG. 3 of an embodiment of the disclosure.

FIG. 5 is a perspective view of an embodiment of the disclosure.

### (j) DETAILED DESCRIPTION OF THE INVENTION

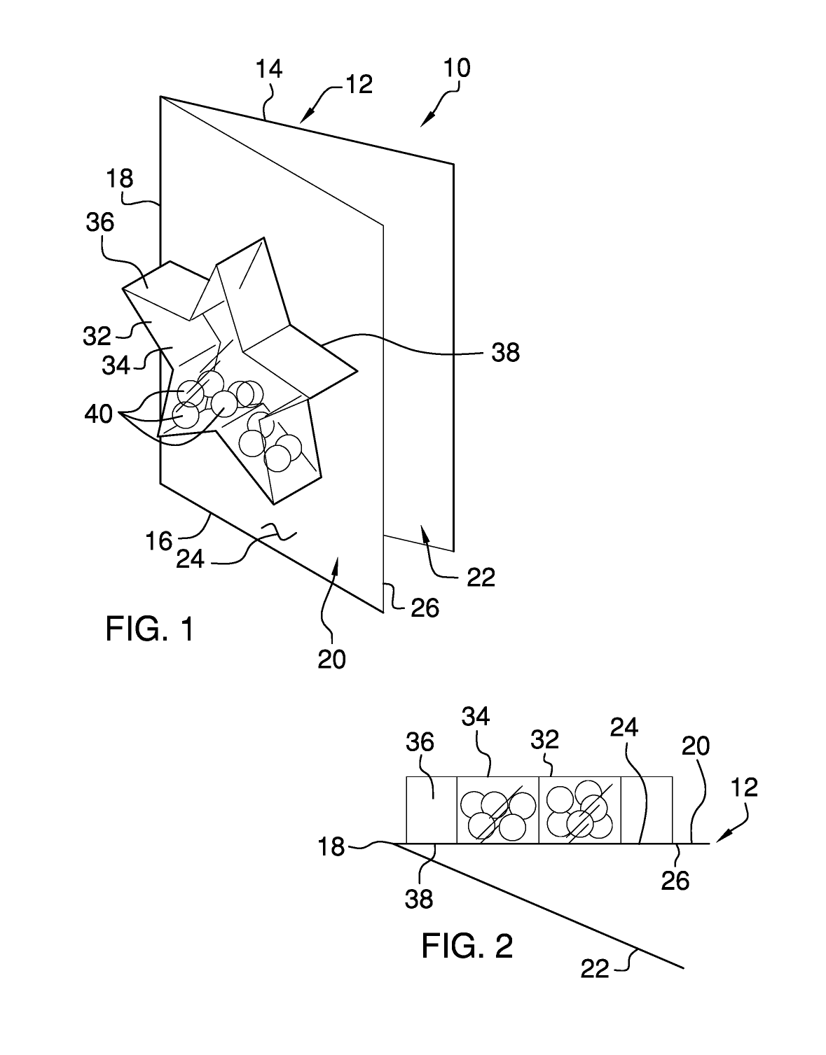

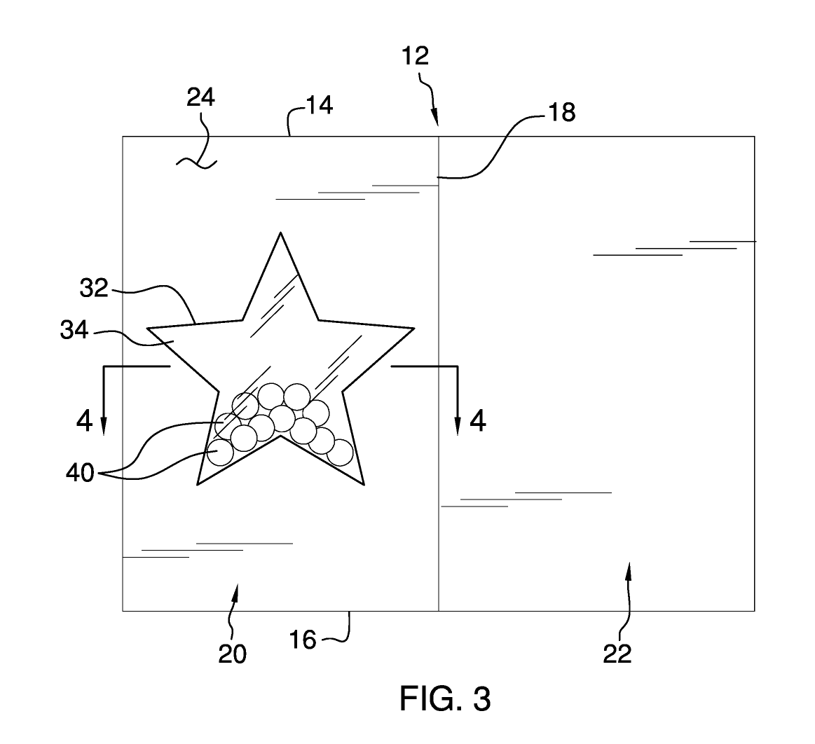

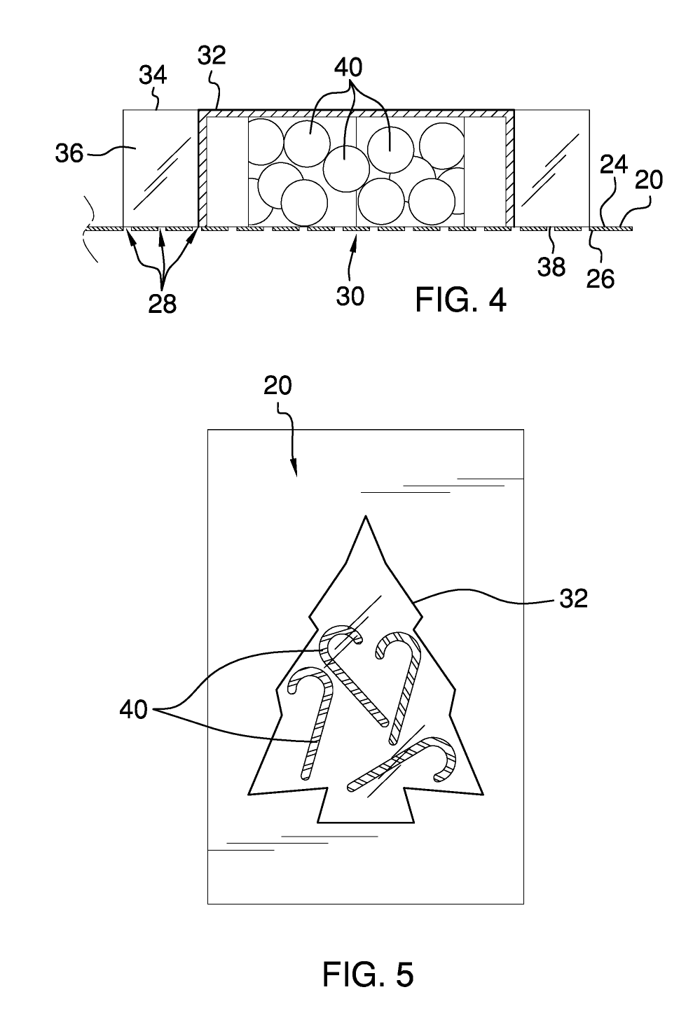

With reference now to the drawings, and in particular to FIGS. 1 through 5 thereof, a new card device embodying the principles and concepts of an embodiment of the disclosure and generally designated by the reference numeral 10 will be described.

As best illustrated in FIGS. 1 through 5, the greeting card assembly 10 generally comprises a card 12 that has a top edge 14 and bottom edge 16. The card 12 has a fold 18 extending between the top edge 14 and the bottom edge 16 to define a first half 20 that is hingedly coupled to a second half 22. The fold 18 is centrally positioned on the card 12 and the first half 20 has a first surface 24 and a second surface 26. The first half 20 has a plurality of perforations 28 extending through the first 24 and second 26 surfaces to define a removable portion 30 of the card 12. The removable portion 30 is selectively torn away from the card 12 and the card 12 may be a greeting card or the like.

A container 32 is provided and the container 32 is removably coupled to the card 12. The container 32 has a first wall 34 and a perimeter wall 36 extending away from the first wall 34. The perimeter wall 36 has a distal edge 38 with respect to the first wall 34 and the distal edge 38 is coupled to the first surface 24 of the first half 20. Moreover, the distal edge 38 is aligned with the perforations 28 such that the container 32 is positioned on the removable portion 30 of the card 12.

The container 32 is comprised of a translucent material such as clear plastic or the like. The distal edge 38 may have a plurality of intersecting sides. Thus, the container 32 may be shaped like a star, a square and any other geometric shape. Additionally, the perforations 28 may be arranged in a geometric shape that corresponds to the shape defined by the distal edge 38. A plurality of objects 40 is provided and each of the objects 40 is positioned in the container 32. The plurality of objects 40 may be removed from the container 32 when the container 32 is removed from the card 12. Additionally, the objects 40 may be candy for eating, trinkets and any other object 40.

In use, the card 12 is presented to a user to celebrate holidays, birthdays and any other meaningful circumstance. The container 32 is selectively urged away from the card 12 to tear the perforations 28. Thus, the container 32 and the removable portion 30 are selectively removed from the card 12. The removable portion 30 is removed from the container 32 thereby facilitating the objects 40 to be removed from the container 32.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A greeting card assembly being configured to contain a plurality of objects, said assembly comprising:
a card having a fold therein to define a first half being hingedly coupled to a second half, said first half having a first surface and a second surface, said first half having a plurality of perforations extending through said first and second surfaces to define a removable portion of said card wherein said removable portion is configured to be selectively torn away from said card;
a container being removably coupled to said card, said container being comprised of a translucent material, said container being positioned on said removable portion of said card wherein said container is removed from said card with said removable portion; and
a plurality of objects, each of said objects being positioned in said container, said plurality of objects being removable from said container when said container is removed from said card.

2. (canceled)

3. The assembly according to claim 1, wherein said container has a first wall and a perimeter wall extending away from said first wall, said perimeter wall having a distal edge with respect to said first wall, said distal edge being coupled to said first surface of said first half.

4. The assembly according to claim 3, wherein said distal edge is aligned with said perforations such that said container is positioned on said removable portion of said card.

5. A greeting card assembly being configured to contain a plurality of objects, said assembly comprising:
a card having a fold therein to define a first half being hingedly coupled to a second half, said first half having a first surface and a second surface, said first half having a plurality of perforations extending through said first and second surfaces to define a removable portion of said card wherein said removable portion is configured to be selectively torn away from said card;
a container being removably coupled to said card, said container having a first wall and a perimeter wall extending away from said first wall, said perimeter wall having a distal edge with respect to said first wall, said distal edge being coupled to said first surface of said first half, said distal edge being aligned with said perforations such that said container is positioned on said removable portion of said card wherein said container is removed from said card with said removable portion when said removable portion is removed from said card, said container being comprised of a translucent material; and
a plurality of objects, each of said objects being positioned in said container, said plurality of objects being removable from said container when said container is removed from said card.
